(19) United States
(12) Patent Application Publication
(10) Pub. No.: US 2008/0185836 A1
(43) Pub. Date: Aug. 7, 2008

(54) Pipe Nipple

(75) Inventor: Thomas C. Bly, Erie, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: Accudyn Products, Inc.

(21) Appl. No.: 11/671,710

(22) Filed: Feb. 6, 2007

(51) Int. Cl. F16L 47/16

(52) U.S. Cl. 285/18

(57) ABSTRACT

A pipe nipple comprising a first end, a second end, and a longitudinal cavity extending through it is presented. A threaded outer surface is located at about the first end. A pipe connector is located at about the second end. The longitudinal cavity has an internal engagement surface over its length shaped to engage a tool insertable into it.

### BACKGROUND

Pipe nipples are used in many applications to provide a fluid connection between a device and a fluid conduit. Pipe nipples are typically short tubes having an outer thread at about a first end for mounting the pipe nipple on a device and having a pipe connector at about a second end for accepting a fluid conduit. Some external engagement surface for engaging a tool to install or extract the pipe nipple is usually provided near the second end. Pipe nipples are typically manufactured from brass or other metals. Metal pipe nipples usually have smooth cylindrical inner diameters.

Pipe nipples installed on devices that are subject to motion, vibration, or other stresses may break off at the installation point, leaving a portion of the pipe nipple imbedded in the device. If this happens, the installation mechanism is also usually shorn off making the embedded portion difficult to remove.

### SUMMARY

A pipe nipple is provided having a first end, a second end, and a longitudinal cavity that extends through the pipe nipple. A threaded outer surface is located at about the first end by which the pipe nipple is mounted to a device. A pipe connector to which fluid conduits are mounted is located at about the second end. The longitudinal cavity has an internal engagement surface over its length for engaging a tool insertable into it. For example, the internal engagement surface can have a hexagonal shape, or any other convenient shape, for receiving a tool of a complementary shape to enable the pipe nipple to be tightened onto or removed from a device.

The pipe connector can be any configuration useful for mounting a fluid conduit to the pipe nipple such as, for example, a quick-connect coupling, a hose barb, a straight pipe, a female threaded end, or a male threaded end. An external engagement surface for engaging a tool can be located on the outside surface of the pipe nipple near the second end.

In one embodiment, the pipe nipple could include an internal support that is embedded in the body of the pipe nipple to provide structural support and strength. The internal support could be a tube, a series of rings, a series of rods, or a series of tubes.

Those skilled in the art will realize that this invention is capable of embodiments that are different from those shown and that details of the structure of the pipe nipple can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1A is a perspective view of an embodiment of the pipe nipple having a pipe connector that is a quick connect coupling;

FIG. 1B is a perspective view of a different embodiment of the pipe nipple having a pipe connector that is a hose barb;

FIG. 1C is a perspective view of a different embodiment of the pipe nipple having a pipe connector that is a straight end;

FIG. 1D is a perspective view of a different embodiment of the pipe nipple having a pipe connector that is male threaded end;

FIG. 1E is a perspective view of a different embodiment of the pipe nipple having a pipe connector that is a female threaded end;

FIG. 2 is a cross sectional view through the line 2-2 shown in FIG. 1;

FIG. 3 is a cross sectional view through the line 3-3 shown in FIG. 1;

FIG. 4A is a cross sectional view of a different embodiment of the pipe nipple having a different configuration of internal engagement surfaces;

FIG. 4B is a cross sectional view of a different embodiment of the pipe nipple having a different configuration of internal engagement surfaces;

FIG. 4C is a cross sectional view of a different embodiment of the pipe nipple having a different configuration of internal engagement surfaces;

FIG. 4D is a cross sectional view of a different embodiment of the pipe nipple having a different configuration of internal engagement surfaces;

FIG. 4E is a cross sectional view of a different embodiment of the pipe nipple having a different configuration of internal engagement surfaces;

FIG. 4F is a cross sectional view of a different embodiment of the pipe nipple having a different configuration of internal engagement surfaces;

FIG. 4G is a cross sectional view of a different embodiment of the pipe nipple having a different configuration of internal engagement surfaces;

FIG. 4H is a cross sectional view of a different embodiment of the pipe nipple having a different configuration of internal engagement surfaces;

FIG. 4I is a cross sectional view of a different embodiment of the pipe nipple having a different configuration of internal engagement surfaces;

FIG. 5A is a cross sectional view of a different embodiment of the pipe nipple showing an internal tube in the body of the pipe nipple;

FIG. 5B is a cross sectional view of a different embodiment of the pipe nipple showing a series of internal rings in the body of the pipe nipple;

FIG. 5C is a cross sectional view of a different embodiment of the pipe nipple showing a series of internal rods in the body of the pipe nipple; and

FIG. 5D is a cross sectional view of a different embodiment of the pipe nipple showing a series of internal tubes in the body of the pipe nipple.

### DETAILED DESCRIPTION

Referring to the drawings, some of the reference numerals are used to designate the same or corresponding parts through several of the embodiments and figures shown and described. Corresponding parts are denoted in specific embodiments with the addition of lowercase letters. Variations of corresponding parts in form or function that are depicted in the figures are described. It will be understood that generally variations in the embodiments can be interchanged without deviating from the invention.

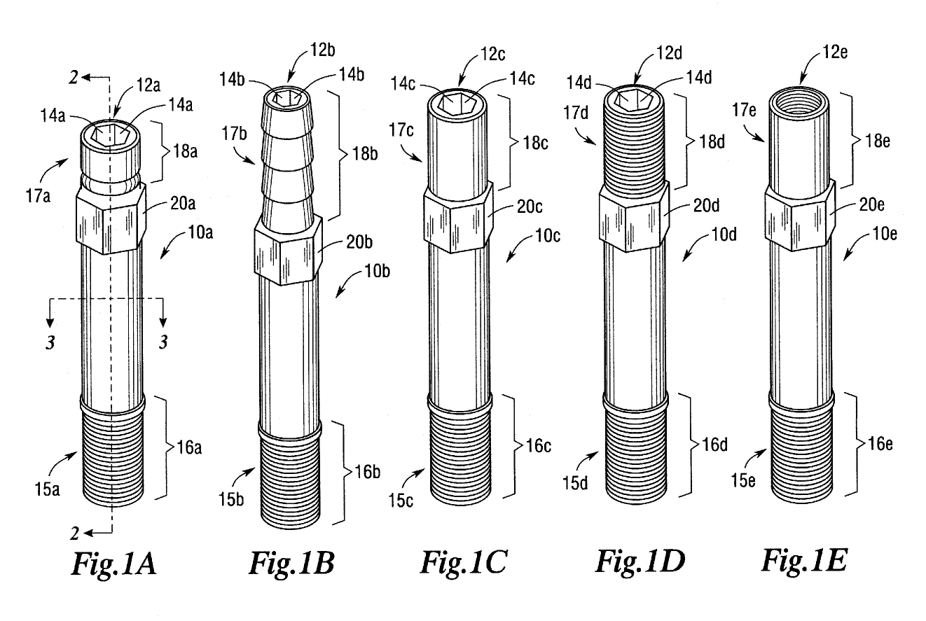

FIG. 1A shows an improved pipe nipple 10a with a longitudinal cavity 12a extending through it. The longitudinal cavity 12a has internal engagement surfaces 14a, in this case a hexagonal formation, for engaging a tool to enable installation or extraction of the pipe nipple 10a. A threaded outer surface 16a is located at about a first end 15a of the pipe nipple 10a by which the pipe nipple 10a is mountable on a device or system requiring a connection to a fluid conduit. A pipe connector 18a, in this case a quick-connect coupling, is located at about a second end 17a of the pipe nipple 10a. The pipe nipple 10a has external engagement surfaces 20a near the second end 17a by which the pipe nipple 10a may be installed or extracted using a wrench, spanner, or other appropriate tool that will engage the external engagement surfaces 20a. In the embodiment shown in FIGS. 1A through 1E, the external engagement surfaces 20 comprise a hexagonal surface. The pipe nipple is sized in diameter and length as needed for the particular application.

The threaded outer surface 16a at about the first end 15a is preferably of the self-sealing type that has a slight interference fit with internal female threads of devices on which the pipe nipple 10a is mounted. This slight interference deforms the threads as the pipe nipple 10a passes into the corresponding internal threads of a device during installation. This creates a seal against the device without requiring the use of thread sealants.

The pipe connector 18a at the second end 17a may be of types other than a quick connect coupling as shown in FIG. 1A. The pipe connector 18a may be a hose barb (shown in FIG. 1B, item 18b), a straight pipe (shown in FIG. 1C, item 18c), a male threaded end (shown in FIG. 1D, item 18d), a female threaded end (shown in FIG. 1E, item 18e), or any other pipe connector called for by the particular application. These pipe connectors are shown as examples and are not meant to limit the possible types of pipe connectors that could be used.

The embodiment shown in FIG. 1E has two types of internal engagement surfaces: the female threaded end 18e at the second end 17a and the internal engagement surface (not shown) over the remaining length of the longitudinal cavity 12e. The female threaded end 18e permits unrestricted passage of an engagement tool that corresponds to the internal engagement surfaces (not shown). This is accomplished by having the inner diameter of the female threaded end 18e larger than the inner diameter of the internal engagement surfaces (not shown) such that the threads of the female threaded end 18e do not interfere with access to the internal engagement surfaces (not shown) of the pipe nipple 10e.

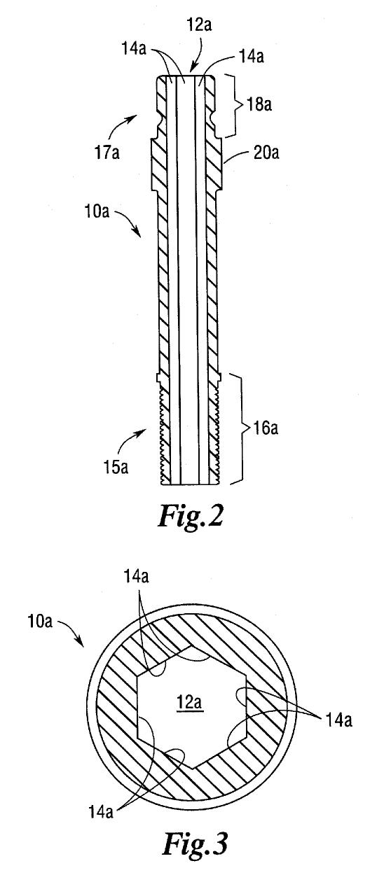

FIG. 2 shows that the internal engagement surfaces 14a are intended to extend substantially through the longitudinal cavity 12a of the pipe nipple 10a. Should the pipe nipple 10a be damaged such that it cannot be removed using the external engagement surfaces 20a, the internal engagement surfaces 14a allow the pipe nipple 10a to be extracted with an appropriate tool. For example if the pipe nipple 10a were used in the plastic injection molding industry, it would be mounted onto an injection mold at an insertion point through which liquid plastics are injected into the mold. The pipe nipple 10a would be subject to high heat, pressure, motion, vibration, or other stresses that may cause it to break off at the installation point leaving a portion of the pipe nipple 10a imbedded in the mold. If this happens, the external engagement surfaces 20a would likely also be shorn off. However the internal engagement surfaces 14a of the longitudinal cavity 12a would still be accessible no matter where the pipe nipple breaks along its length. This allows the pipe nipple 10a to be readily extracted using an appropriate extraction tool.

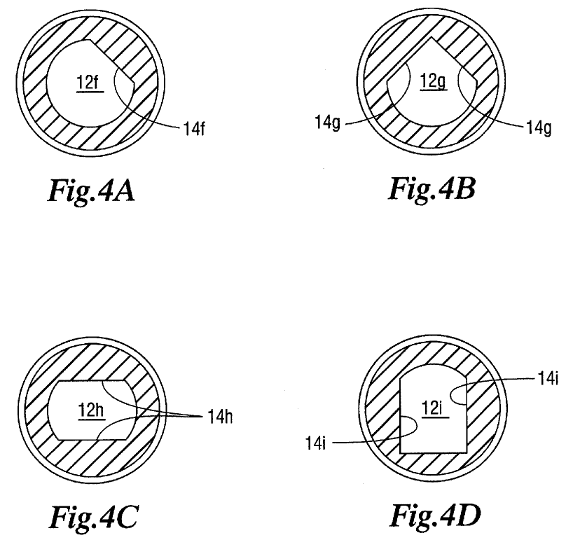

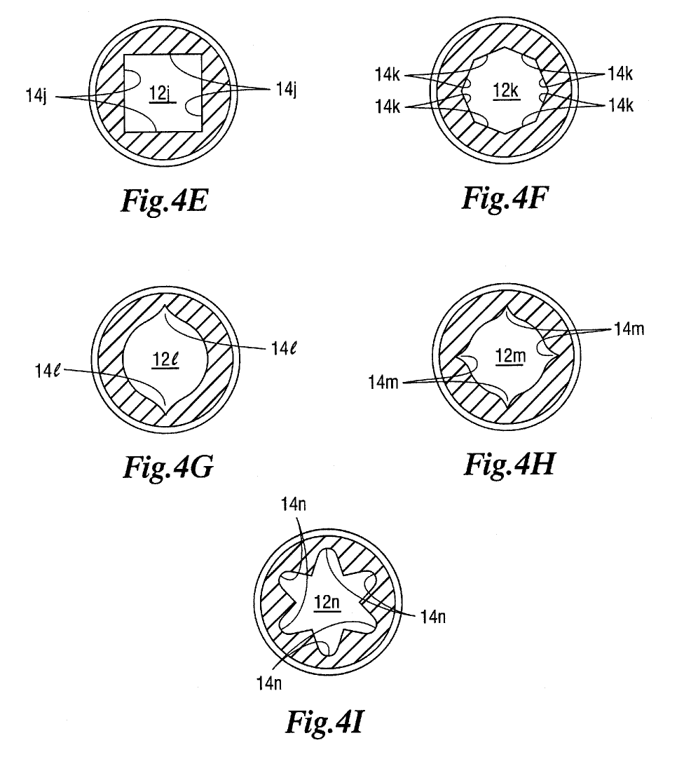

FIG. 3 shows the internal engagement surfaces 14a of the pipe nipple 10a of FIGS. 1A and 2 to be hexagonal to allow a hex key tool to be used as a corresponding extraction tool. However it will be understood that other configurations of internal engagement surfaces 14a are also possible. FIGS. 4A through 4I show other possible configurations of internal engagement surfaces 14f through 14n. These configurations are shown as examples and are not meant to limit the possible configurations. So long as the internal engagement surface has a corresponding extraction tool that would fit and allow the pipe nipple to be extracted, any configuration of internal engagement surfaces may be used.

The preferred embodiment of the pipe nipple can be manufactured through an injection molding process using heat meltable plastic materials in an injection molding machine. The desired shape of the pipe nipple is controlled by a mold, which is a reverse image of the desired part. The injection molding machine has two basic parts: the injection unit that melts the plastic and injects it into the mold; and the clamping unit that holds the mold. The injection unit injects melted plastic into the closed mold. The clamping unit holds the mold closed during this time. After the required cooling period, the clamping unit opens the mold and ejects the finished part. Corers mechanically move into and out of the finished part to form the longitudinal cavities with the internal engagement surfaces.

The pipe nipple could be manufactured from any material found useful for the particular application. Such materials include, but are not limited to, any thermoplastic resin. Nylon 6/6 thermoplastic resin with 33% glass fiber filler has been found to be appropriate for use in conditions where the pipe nipple would be exposed to temperatures up to 160 degrees Fahrenheit. Other thermoplastic resin materials that can be used include polypropylene resin with glass fiber filler or polyetherimide resin.

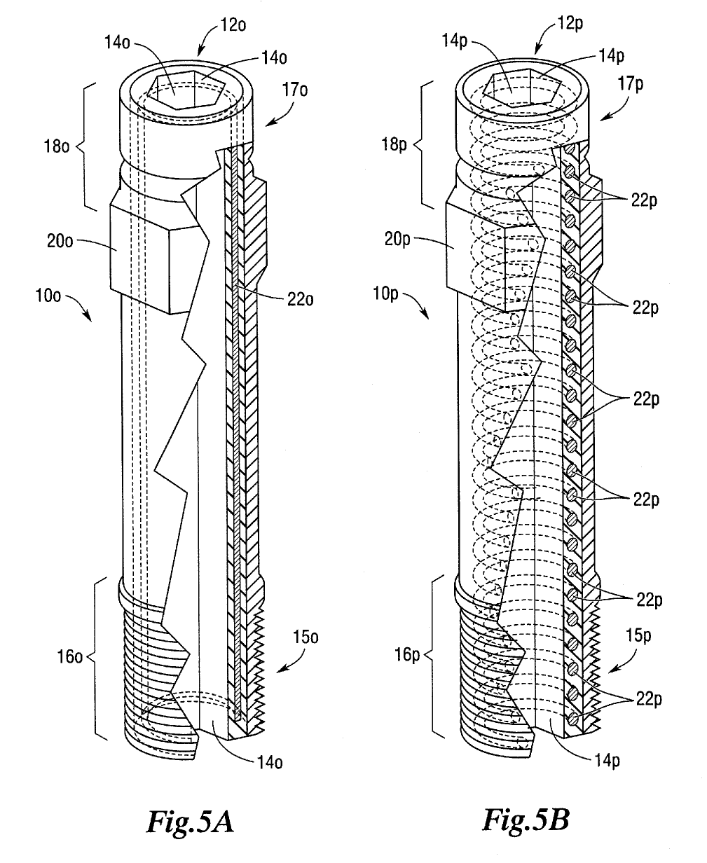

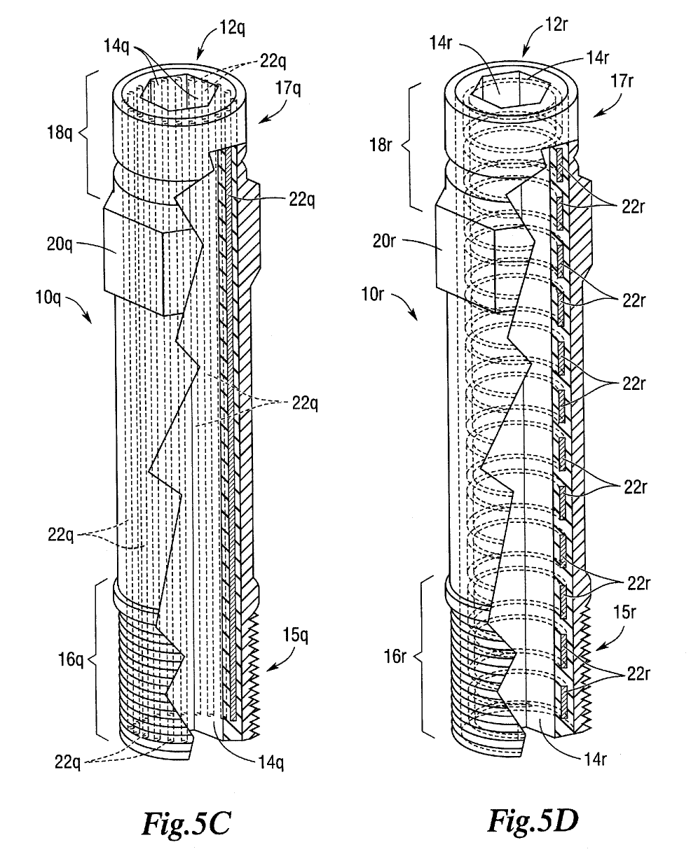

In applications that require a more robust pipe nipple, internal support elements could be incorporated into the body of the pipe nipple. FIG. 5A shows a cross section of an embodiment of pipe nipple 10o that incorporates an internal support 22o in the body of the pipe nipple 10o. The internal support 22o provides additional strength to the pipe nipple 10o allowing it to withstand greater stresses without incurring damage to the body of the pipe nipple 10o. The internal support 22o may be made of steel or any other material that would provide additional structural support to the pipe nipple 10o. In the embodiment shown in FIG. 5A the internal support 22o is a tube that is about the length of the pipe nipple 10o.

Other configurations of internal supports are also possible. For example, the embodiment shown in FIG. 5B shows a pipe nipple 10p which has embedded internal supports 22p that are a series of rings spaced along the length of the pipe nipple 10p. The embodiment shown in FIG. 5C shows a pipe nipple 10q that has embedded internal supports 22q that are a series of rods that are about the length of the pipe nipple 10q and are spaced around the perimeter of the body of the pipe nipple 10q. The embodiment shown in FIG. 5D shows a pipe nipple 10r that has embedded internal supports 22r that are a series of tubes along the length of the pipe nipple 10r.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed:

1. A pipe nipple comprising:
a first end, a second end, and a longitudinal cavity extending through said pipe nipple;
a threaded outer surface at about said first end;
a pipe connector at about said second end; and
said longitudinal cavity having an internal engagement surface over the length of said longitudinal cavity shaped to engage a tool insertable into said longitudinal cavity.

2. The pipe nipple of claim 1 in which said internal engagement surface is a hexagonal shape.

3. The pipe nipple of claim 1 in which said pipe connector is a quick-connect coupling, a hose barb, a straight pipe, a female threaded end, or a male threaded end.

4. The pipe nipple of claim 1 further comprising an external engagement surface shaped to engage a tool, said external engagement surface located on the outside surface of said pipe nipple near said second end.

5. The pipe nipple of claim 1 further comprising an external hexagonal surface for engaging a tool, said external hexagonal surface located on the outside surface of said pipe nipple near said second end.

6. The pipe nipple of claim 1 further in which said threaded outer surface comprises threads which have a slight interference fit when threaded into a threaded inner surface such that said threads are slightly deformed and form a seal without having to use a pipe sealant.

7. The pipe nipple of claim 1 in which said pipe nipple is made from nylon 6/6 thermoplastic resin with 33% glass fiber filler, polypropylene resin with glass fiber filler, or polyetherimide resin.

8. The pipe nipple of claim 1 in which said pipe nipple is made from any thermoplastic resin.

9. The pipe nipple of claim 1 in which internal supports are incorporated into the body of said tube.

10. The pipe nipple of claim 1 in which internal supports are incorporated into the body of said tube; and
said internal supports comprising a tube, a series of rings, a series of rods, or a series of tubes.
